(19) United States
(12) Patent Application Publication
(10) Pub. No.: US 2020/0302559 A1
(43) Pub. Date: Sep. 24, 2020

(54) GAS ENERGY-SAVING PROMPTING METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/359,970

(22) Filed: Mar. 20, 2019

(51) Int. Cl. G06Q 50/06; G06Q 30/02; G06Q 30/04

(52) U.S. Cl. CPC G06Q 50/06; G06Q 30/04; G06Q 30/0205

(57) ABSTRACT

The present invention provides a gas energy-saving prompting method based on a compound Internet of Things (IoT) and an IoT system, and relates to the field of energy consumption. The gas energy-saving prompting method based on the compound Internet of Things (IoT) and the IoT system generate the monthly normal gas usage amount associated with each user sub-platform based on the information on family size, family members' ages, geographic location and seasons sent by each of the user sub-platforms as well as the pre-trained neural network algorithm model. When the management platform judges that the monthly actual gas usage amount of the user is greater than the monthly normal gas usage amount, a gas overconsumption prompt is generated. The calculated monthly normal gas usage amount meets the practical requirements, with high reliability and reference value, so that the system targets to remind an individual family to save gas, but not stop the supply of gas or send a prompt in a whole area, improving the user experience.

### TECHNICAL FIELD

The present invention relates to the field of energy consumption, and in particular to a gas energy-saving prompting method based on a compound Internet of Things (IoT) and an IoT system.

### BACKGROUND

Natural gas is one of safe gases, and it contains no carbon monoxide and is lighter than the air. Once it leaks, it will diffuse upwards immediately and will not accumulate to form explosive gas. Its safety is relatively higher than that of other gases. The use of natural gas as energy can reduce the use of coal and oil, thus significantly improving environmental pollution; natural gas, as a clean energy, can reduce nearly 100% of sulfur dioxide and dust emission, 60% of carbon dioxide emissions and 50% of nitrogen oxides emissions, and contribute to reducing acid rain formation, alleviating the greenhouse effects of the earth, so as to fundamentally improve environmental quality. With the development of society, the use of natural gas needs to be saved because of the increasing number of people who use natural gas and the fact that natural gas is a non-renewable resource. In the prior art, the main way to save natural gas is to regionally stop the supply of gas at cities or residence communities, and there is not yet a mature technical limitation or prompt to households over-consuming gas of the energy-saving needs.

### SUMMARY

In view of this, an objective of the present invention is to provide a gas energy-saving prompting method based on a compound Internet of Things (IoT) and an IoT system to improve the above problems.

According to a first aspect, the present invention provides a gas energy-saving prompting method based on a compound IoT, being applied to a gas energy-saving prompting IoT system based on the compound IoT; the gas energy-saving prompting IoT system based on the compound IoT comprises a plurality of object sub-platforms, a sensor network platform, a management platform, a service platform, and a plurality of user sub-platforms; each of the object sub-platforms comprises a gas meter; and the gas energy-saving prompting method based on the compound IoT comprises:

sending, by each of the user sub-platforms, the information on family size, family members' ages, geographic location and seasons to the service platform;

receiving, by the service platform, the information on family size, family members' ages, geographic location and seasons sent by each of the user sub-platforms, and sending the information to the management platform;

generating, by the management platform, the monthly normal gas usage amount associated with each user sub-platform based on the information on family size, family members' ages, geographic location and seasons sent by each of the user sub-platforms as well as the pre-trained neural network algorithm model;

receiving, by the management platform, the monthly normal gas usage amount associated with each of the user sub-platforms sent by the service platform and the monthly actual gas usage amount sent by each of the object sub-platforms via the sensor network platform, judging whether the monthly actual gas usage amount associated with each of the user sub-platforms is greater than the monthly normal gas usage amount, and if so, generating a gas overconsumption prompt, and sending the prompt and monthly normal gas usage amount to the service platform; and

sending, by the service platform, the gas overconsumption prompt to the corresponding user sub-platform.

According to a second aspect, the present invention also provides a gas energy-saving prompting IoT system based on the compound IoT; the gas energy-saving prompting IoT system based on the compound IoT comprises a plurality of object sub-platforms, a sensor network platform, a management platform, a service platform, and a plurality of user sub-platforms; each of the object sub-platforms comprises a gas meter; each object sub-platform, the management platform, the service platform, and each user sub-platform are communicatively connected via the sensor network platform;

each of the user sub-platforms is used to send the information on family size, family members' ages, geographic location and seasons to the service platform;

the service platform is configured to receive the information on family size, family members' ages, geographic location and seasons sent by each of the user sub-platforms, and send the information to the management platform;

the management platform is configured to generate the monthly normal gas usage amount associated with each user sub-platform based on the information on family size, family members' ages, geographic location and seasons sent by each user sub-platform as well as the pre-trained neural network algorithm model;

the management platform is configured to receive the monthly normal gas usage amount associated with each of the user sub-platforms sent by the service platform and receive the monthly actual gas usage amount sent by each of the object sub-platforms via the sensor network platform, judge whether the monthly actual gas usage amount associated with each of the user sub-platforms is greater than the monthly normal gas usage amount, and if so, generate a gas overconsumption prompt, and send the prompt and monthly normal gas usage amount to the service platform; and

the service platform is configured to send the gas overconsumption prompt to the corresponding user sub-platform.

Compared with the prior art, the gas energy-saving prompting method based on a compound Internet of Things (IoT) and an IoT system provided by the present invention first use each of the user sub-platforms to send the information on family size, family members' ages, geographic location and seasons to the service platform, wherein the family size, family members' ages, geographic location and seasons are the most referential factors of the household gas usage amount, and then generate the monthly normal gas usage amount associated with each user sub-platform based on the information on family size, family members' ages, geographic location and seasons sent by each of the user sub-platforms as well as the pre-trained neural network algorithm model, wherein the reliability, reference value and accuracy of monthly normal gas usage amount calculated by using the pre-trained neural network algorithm model are high, and the calculated monthly normal gas usage amount meets the practical requirements of people who use gas. When the management platform judges that the monthly actual gas usage amount of the user is greater than the monthly normal gas usage amount, a gas overconsumption prompt is generated. The service platform is configured to send the gas overconsumption prompt to the corresponding user sub-platform, to prompt the user to save gas for gas overconsumption. Through the above-mentioned ways, gas overconsumption is no longer measured by using a single threshold, but by combining the factors of information on family size, family members' ages, geographic location and seasons to consider whether each family uses gas excessively, and the calculated monthly normal gas usage amount meets the practical requirements, with high reliability and reference value; the system sends the gas overconsumption prompt only to the families who use gas excessively, and it targets to remind the individual families to save gas, but not stop the supply of gas or send a prompt in a whole area, improving the experience of users.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates an interactive schematic diagram of a gas energy-saving prompting IoT system based on a compound IoT provided by an embodiment of the present invention; and

FIG. 2, FIG. 3, and FIG. 4 illustrate flowcharts of a gas energy-saving prompting method based on a compound IoT provided by an embodiment of the present invention.

Numerals in the drawings: 101—object sub-platform; 102—sensor network platform; 103—management platform; 104—service platform; 105—user sub-platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

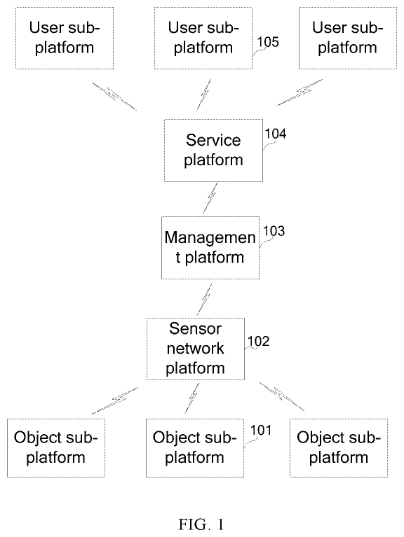

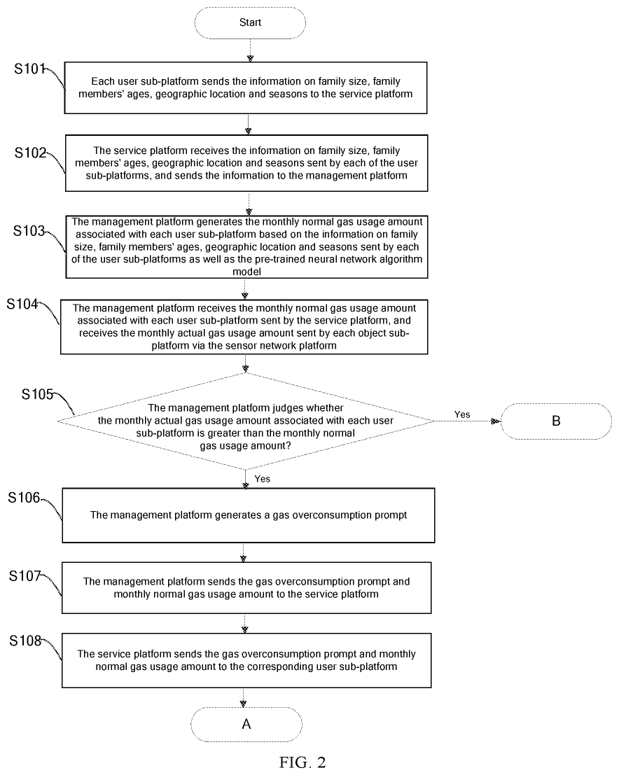

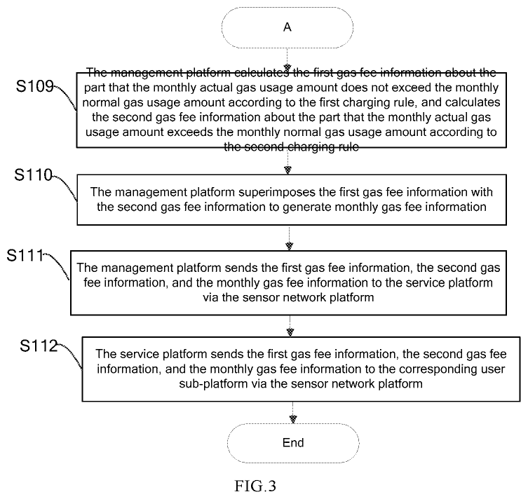

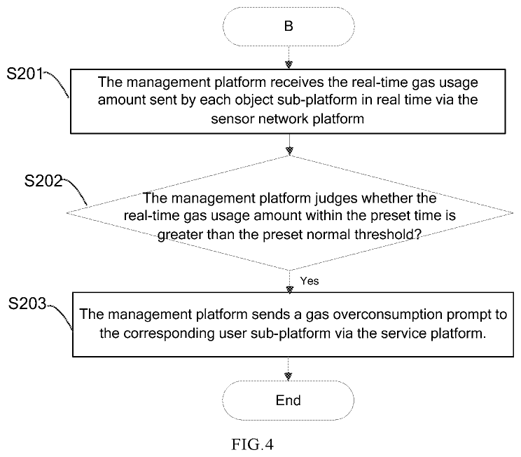

Referring to FIG. 1, the present invention provides a gas energy-saving prompting method based on a compound IoT, which is applied to a gas energy-saving prompting IoT system based on a compound IoT. The gas energy-saving prompting IoT system based on the compound IoT includes a plurality of object sub-platforms 101, a sensor network platform 102, a management platform 103, a service platform 104, and a plurality of user sub-platforms 105. In this embodiment, each of the object sub-platforms 101 includes a gas meter, and the service platform 104 includes a gas company service platform. As shown in FIG. 2, the gas energy-saving prompting method based on the compound IoT may include the following steps:

Step S101: Each of the user sub-platforms 105 sends the information on family size, family members' ages, geographic location and seasons to the service platform 104.

When the user registers with the application installed on the user sub-platform 105, the user can input the residence community the family is located at and location of the residence community, floor and room number (i.e. geographical location information), family size, and family members' ages and save them.

Step S102: The service platform 104 receives the information on family size, family members' ages, geographic location and seasons sent by each user sub-platform 105, and sends the information to the management platform 103.

Step S103: The management platform 103 generates the monthly normal gas usage amount associated with each user sub-platform 105 based on the information on family size, family members' ages, geographic location and seasons sent by each of the user sub-platforms 105 as well as the pre-trained neural network algorithm model.

The neural network algorithm model has self-adaptive and self-organizing abilities, and it makes classification or imitation with a given sample standard, and changes the synaptic weight value in the process of learning or training according to the training sample to meet the requirements of surrounding environment.

Step S104: The management platform 103 receives the monthly normal gas usage amount associated with each of the user sub-platforms 105 sent by the service platform 104, and receives the monthly actual gas usage amount sent by each of the object sub-platforms 101 via the sensor network platform 102.

Step S105: The management platform 103 judges whether the monthly actual gas usage amount associated with each of the user sub-platforms 105 is greater than the monthly normal gas usage amount. If so, Step S105 and Step S108 are executed.

Step S106: The management platform 103 generates a gas overconsumption prompt.

Step S107: The management platform 103 sends the gas overconsumption prompt and monthly normal gas usage amount to the service platform 104 via the sensor network platform 102.

Step S108: The service platform 104 sends the gas overconsumption prompt and monthly normal gas usage amount to the corresponding user sub-platform 105.

The user can view the gas overconsumption prompt on the user sub-platform 105, so as to save gas, and can take the monthly normal gas usage amount as the reference for the next month.

As shown in FIG. 3, the gas energy-saving prompting method based on the compound IoT may also include the following steps:

Step S109: The management platform 103 calculates the first gas fee information about the part that the monthly actual gas usage amount does not exceed the monthly normal gas usage amount according to the first charging rule, calculates the second gas fee information about the part that the monthly actual gas usage amount exceeds the monthly normal gas usage amount according to the second charging rule.

It should be noted that the first charging rule is to charge the gas usage amount according to the normal charging rule, and the second charging rule charges the gas per cubic meter more expensive than the first charging rule, to limit the user using gas excessively for saving.

Step S110: The management platform 103 superimposes the first gas fee with the second gas fee to generate monthly gas fee information.

Step S111: The management platform 103 sends the first gas fee information, the second gas fee information, and the monthly gas fee information to the service platform 104 via the sensor network platform 102.

Step S112: The service platform 104 sends the first gas fee information, the second gas fee information, and the monthly gas fee information to the corresponding user sub-platform 105.

It should be noted that in this embodiment, the user sub-platform 105 comprises the first display area, second display area, and third display area. The first display area is used to display the first gas fee information, the second display area is used to display the second gas fee information, and the third display area is used to display the monthly gas fee information, in which the first display area is rendered in green, and the second display area is rendered in red with a warning prompt. In this way, the user is prompted more observably to save gas.

In addition, as shown in FIG. 4, in this embodiment, the gas energy-saving prompting method based on the compound IoT may also include the following steps:

Step S201: The management platform 103 receives the real-time gas usage amount sent by each of the object sub-platforms 101 in real time via the sensor network platform 102.

Step S202: The management platform 103 judges whether the real-time gas usage amount within the preset time is greater than the preset normal threshold. If so, Step S203 is executed.

When the real-time gas usage amount within the preset time is greater than the preset normal threshold, it indicates that the gas is not normally used (for example, the valve is always open and forgotten to be closed, or gas leakage occurs), resulting in the waste of gas.

Step S203: The management platform 103 sends the fault prompt information to the corresponding user sub-platform via the service platform.

Referring to FIG. 1, the present invention also provides a gas energy-saving prompting IoT system based on a compound IoT, which includes a plurality of object sub-platforms 101, a sensor network platform 102, a management platform 103, a service platform 104, and a plurality of user sub-platforms 105. Each of the object sub-platforms 101 includes a gas meter, and each of the object sub-platforms 101, the management platform 103, the service platform 104, and each of the user sub-platforms 105 are communicatively connected via the sensor network platform 102. Herein, the service platform 104 includes at least one of a gas company service platform 104, a government service platform 104, or a social operator service platform 104.

Each of the user sub-platforms 105 is configured to send the information on family size, family members' ages, geographic location and seasons to the service platform 104.

The service platform 104 is configured to receive the information on family size, family members' ages, geographic location and seasons sent by each user sub-platform 105, and send the information to the management platform 103.

The management platform 103 generates the monthly normal gas usage amount associated with each user sub-platform 105 based on the information on family size, family members' ages, geographic location and seasons sent by each of the user sub-platforms 105 as well as the pre-trained neural network algorithm model.

The management platform 103 is configured to receive the monthly normal gas usage amount associated with each of the user sub-platforms 105 sent by the service platform 104 and receive the monthly actual gas usage amount sent by each of the object sub-platforms 101 via the sensor network platform 102, judge whether the monthly actual gas usage amount associated with each of the user sub-platforms 105 is greater than the monthly normal gas usage amount, and if so, generate a gas overconsumption prompt, and send the prompt and monthly normal gas usage amount to the service platform 104 via the sensor network platform 102.

The service platform 104 is configured to send the gas overconsumption prompt to the corresponding user sub-platform 105.

The management platform 103 is also configured to receive the real-time gas usage amount sent by each of the object sub-platforms 101 in real time via the sensor network platform 102, and send the fault prompt information to the corresponding user sub-platform 105 via the service platform 104 if the real-time gas usage amount within the preset time is greater than the preset normal threshold.

The management platform 103 is also configured to, if the monthly actual gas usage amount associated with the user sub-platform 105 is greater than the monthly normal gas usage amount, calculate the first gas fee information about the part that the monthly actual gas usage amount does not exceed the monthly normal gas usage amount according to the first charging rule, calculate the second gas fee information about the part that the monthly actual gas usage amount exceeds the monthly normal gas usage amount according to the second charging rule, and superimpose the first gas fee information with the second gas fee information to generate the monthly gas fee information, and send the first gas fee information, second gas fee information, and monthly gas fee information to the service platform 104.

The service platform 104 is also configured to send the gas overconsumption prompt to the corresponding user sub-platform 105.

In this embodiment, it should be noted that the user sub-platform 105 comprises the first display area, second display area, and third display area. The first display area is used to display the first gas fee information, the second display area is used to display the second gas fee information, and the third display area is used to display the monthly gas fee information, in which the first display area is rendered in green, and the second display area is rendered in red with a warning prompt.

In conclusion, the gas energy-saving prompting method based on a compound Internet of Things (IoT) and an IoT system provided by the present invention first use each of the user sub-platforms to send the information on family size, family members' ages, geographic location and seasons to the service platform 104, wherein the family size, family members' ages, geographic location and seasons are the most referential factors of the household gas usage amount, and then generate the monthly normal gas usage amount associated with each user sub-platform 105 based on the information on family size, family members ages, geographic location and seasons sent by each of the user sub-platforms 105 as well as the pre-trained neural network algorithm model, wherein the reliability, reference value and accuracy of monthly normal gas usage amount calculated by using the pre-trained neural network algorithm model are high, and the calculated monthly normal gas usage amount meets the practical requirements of people who use gas. When the management platform 103 judges that the monthly actual gas usage amount of the user is greater than the monthly normal gas usage amount, a gas overconsumption prompt is generated. The service platform 104 is configured to send the gas overconsumption prompt to the corresponding user sub-platform 105, to prompt the user to save gas for gas overconsumption. Through the above-mentioned ways, gas overconsumption is no longer measured by using a single threshold, but by combining the factors of information on family size, family members' ages, geographic location and seasons to consider whether each family uses gas excessively, and the calculated monthly normal gas usage amount meets the practical requirements, with high reliability and reference value; the system sends the gas overconsumption prompt only to the families who use gas excessively, and it targets to remind the individual families to save gas, but not stop the supply of gas or send a prompt in a whole area, improving the experience of users.

In several embodiments provided by the present application, it should be understood that the disclosed apparatus and method may also be implemented in other manners. The described apparatus embodiments are merely exemplary. For example, the flowcharts and block diagrams in the drawings illustrate the system architecture, function, and operation of possible implementations of apparatuses, methods, and computer program products according to various embodiments of the present invention. In this regard, each block in the flowcharts or block diagrams may represent a module, program segment, or portion of code, which includes one or more executable instructions for implementing the specified logical function(s). It should also be noted that in some alternative implementation manners, the functions noted in the block may occur out of the sequence noted in the drawings. For example, two continuous blocks, in fact, may be executed concurrently, or in a reverse order, which will depend upon the functions involved. It will also be noted that each block of the block diagrams and/or flowcharts, and combinations of blocks in the block diagrams and/or flowcharts, may be implemented by a special hardware-based IoT system that performs the specified functions or acts, or by using combinations of special hardware and computer instructions.

In addition, each module in the embodiments of the present invention may exist independently, and two or more modules may be integrated into an independent part.

When a function is implemented in the form of the software functional unit and sold or used as a separate product, the function may be stored in a computer readable storage medium. Based on such understanding, the technical solutions of the present invention or the part that makes contributions to the prior art or a part of the technical solutions may be substantially embodied in a form of a software product. The computer software product is stored in a storage medium, and includes several instructions to instruct a computer device (which may be a personal computer, server, network device, or the like) to execute all or some steps of the methods described in the embodiments of the present invention. The foregoing storage medium includes: various media capable of storing a program code, such as a disk, a mobile hard disk, a Read-Only Memory (ROM), a Random Access Memory (RAM), a magnetic disk or an optical disk. It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

The foregoing descriptions are merely specific implementation manners of the present invention, but are not intended to limit a scope of protection of the present invention. Any variation or replacement readily figured out by a person skilled in the art within the technical scope disclosed in the present invention shall fall within the scope of protection of the present invention. Therefore, the scope of protection of the present invention shall be subject to the scope of protection of the claims.

It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

What is claimed is:

1. A gas energy-saving prompting method based on a compound Internet of Things (IoT), wherein the method is applied to a gas energy-saving prompting IoT system based on a compound IoT; the gas energy-saving prompting IoT system based on a compound IoT comprises a plurality of object sub-platforms, a sensor network platform, a management platform, a service platform, and a plurality of user sub-platforms; each of the object sub-platforms comprises a gas meter; and the gas energy-saving prompting method based on the compound IoT comprises:
sending, by each of the user sub-platforms, the information on family size, family members' ages, geographic location and seasons to the service platform;
receiving, by the service platform, the information on family size, family members' ages, geographic location and seasons sent by each of the user sub-platforms, and sending the information to the management platform;
generating, by the management platform, the monthly normal gas usage amount associated with each user sub-platform based on the information on family size, family members' ages, geographic location and seasons sent by each of the user sub-platforms as well as the pre-trained neural network algorithm model;
receiving, by the management platform, the monthly normal gas usage amount associated with each of the user sub-platforms sent by the service platform and the monthly actual gas usage amount sent by each of the object sub-platforms via the sensor network platform, judging whether the monthly actual gas usage amount associated with each of the user sub-platforms is greater than the monthly normal gas usage amount, and if so, generating a gas overconsumption prompt, and sending the prompt and monthly normal gas usage amount to the service platform; and
sending, by the service platform, the gas overconsumption prompt and monthly normal gas usage amount to the corresponding user sub-platform.

2. The gas energy-saving prompting method based on the compound IoT according to claim 1, wherein the management platform receives the real-time gas usage amount sent by each of the object sub-platforms in real time via the sensor network platform, and sends the fault prompt information to the corresponding user sub-platform via the service platform if the real-time gas usage amount within the preset time is greater than the preset normal threshold.

3. The gas energy-saving prompting method based on the compound IoT according to claim 1, wherein if the monthly actual gas usage amount associated with the user sub-platform is greater than the monthly normal gas usage amount, the management platform calculates the first gas fee information about the part that the monthly actual gas usage amount does not exceed the monthly normal gas usage amount according to the first charging rule, calculates the second gas fee information about the part that the monthly actual gas usage amount exceeds the monthly normal gas usage amount according to the second charging rule, superimposes the first gas fee information with the second gas fee information to generate the monthly gas fee information, and sends the first gas fee information, second gas fee information, and monthly gas fee information to the service platform;
the service platform sends the first gas fee information, second gas fee information, and monthly gas fee information to the corresponding user sub-platform.

4. The gas energy-saving prompting method based on the compound IoT according to claim 3, wherein the user sub-platform comprises the first display area, second display area, and third display area; the first display area is used to display the first gas fee information, the second display area is used to display the second gas fee information, and the third display area is used to display the monthly gas fee information, in which the first display area is rendered in green, and the second display area is rendered in red with a warning prompt.

5. The gas energy-saving prompting method based on the compound IoT according to claim 1, wherein the service platform comprises a gas company service platform.

6. A gas energy-saving prompting Internet of Things (IoT) system based on a compound IoT, wherein the gas energy-saving prompting IoT system based on a compound IoT comprises a plurality of object sub-platforms, a sensor network platform, a management platform, a service platform, and a plurality of user sub-platforms; each of the object sub-platforms comprises a gas meter; each object sub-platform, the management platform, the service platform, and each user sub-platform are communicatively connected via the sensor network platform;
each of the user sub-platforms is used to send the information on family size, family members' ages, geographic location and seasons to the service platform;
the service platform is configured to receive the information on family size, family members' ages, geographic location and seasons sent by each of the user sub-platforms, and send the information to the management platform;
the management platform is configured to generate the monthly normal gas usage amount associated with each user sub-platform based on the information on family size, family members' ages, geographic location and seasons sent by each user sub-platform as well as the pre-trained neural network algorithm model;
the management platform is configured to receive the monthly normal gas usage amount associated with each of the user sub-platforms sent by the service platform and receive the monthly actual gas usage amount sent by each of the object sub-platforms via the sensor network platform, judge whether the monthly actual gas usage amount associated with each of the user sub-platforms is greater than the monthly normal gas usage amount, and if so, generate a gas overconsumption prompt, and send the prompt and monthly normal gas usage amount to the service platform; and
the service platform is configured to send the gas overconsumption prompt and monthly normal gas usage amount to the corresponding user sub-platform.

7. The gas energy-saving prompting method based on the compound IoT according to claim 6, wherein the management platform receives the real-time gas usage amount sent by each of the object sub-platforms in real time via the sensor network platform, and sends the fault prompt information to the corresponding user sub-platform via the service platform if the real-time gas usage amount within the preset time is greater than the preset normal threshold.

8. The gas energy-saving prompting IoT system based on the compound IoT according to claim 6, wherein the management platform is further configured to, if the monthly actual gas usage amount associated with the user sub-platform is greater than the monthly normal gas usage amount, calculate the first gas fee information about the part that the monthly actual gas usage amount does not exceed the monthly normal gas usage amount according to the first charging rule, calculate the second gas fee information about the part that the monthly actual gas usage amount exceeds the monthly normal gas usage amount according to the second charging rule, superimpose the first gas fee information with the second gas fee information to generate the monthly gas fee information, and send the first gas fee information, second gas fee information, and monthly gas fee information to the service platform; and
the service platform is further configured to send the first gas fee information, second gas fee information, and monthly gas fee information to the corresponding user sub-platform.

9. The gas energy-saving prompting IoT system based on the compound IoT according to claim 8, wherein the user sub-platform comprises the first display area, second display area, and third display area; the first display area is used to display the first gas fee information, the second display area is used to display the second gas fee information, and the third display area is used to display the monthly gas fee information, in which the first display area is rendered in green, and the second display area is rendered in red with a warning prompt.

10. The gas energy-saving prompting IoT system based on the compound IoT according to claim 6, wherein the service platform comprises a gas company service platform.
